(19) United States
(12) Patent Application Publication
(10) Pub. No.: US 2019/0085616 A1
(43) Pub. Date: Mar. 21, 2019

(54) SECURE HOUSING WITH PREDETERMINED CONTENTS AND DYNAMIC MANAGEMENT

(71) Applicant: MOPEASY, NEUILLY SUR SEINE (FR)

(72) Inventor: Stanislas SOUFFLET, Paris (FR)

(73) Assignee: MOPEASY, NEUILLY SUR SEINE (FR)

(21) Appl. No.: 16/080,072

(22) PCT Filed: Feb. 27, 2017
(86) PCT No.: PCT/FR2017/050434

§ 371 Date: Aug. 27, 2018

(30) Foreign Application Priority Data
Feb. 26, 2016 (FR) 1651602

(51) Int. Cl. E05G 1/10; E05B 19/00; E05G 1/04; E05B 47/00; E05G 1/026; G07C 9/00

(52) U.S. Cl. CPC E05G 1/10; E05B 19/0005; E05G 1/04; E05B 47/0001; E05Y 2900/21; G07C 9/00912; E05B 2047/0067; E05B 47/0002; E05G 1/026

(57) ABSTRACT

The present invention relates to a secure-closure housing (1) comprising a door (5) and a locking device (7), a means for accessing an object identifier, a means for accessing an authenticator of a user that is to deposit the object, means (17) for authenticating a user, a device (11) for identifying an object present in the housing, and a controller (9) of the locking device, suitable for:
when the door is closed and the object identification device indicates an absence of object identification in the housing, sending an unlock command to the locking device only after authentication of the user that is to deposit the object;
sending a lock command after the object identification device has provided an object identifier that corresponds to the identifier received; and
triggering an alarm and preventing the locking of the door when the object identification device provides an object identifier that does not correspond to the object identifier received.

### TECHNICAL FIELD

The present invention concerns a secure housing with predetermined contents and dynamic management. It relates to the field of safes and secure housings.

### STATE OF THE ART

Secure housings that allow an object to be shared between several people, such as an access key for premises (apartment, house, part of a house, garage, annex, etc) or a vehicle, are known to the person skilled in the art. The simplest mode is a locked housing with as many copies of the key as there as users, and which contains the access key to a place or a vehicle. The key opening the housing can be replaced by various access systems such as, for example, a digicode, a biometric imprint, etc.

In the more specific context of vehicle sharing, the most common solution—but reserved for closed fleets of vehicles—is the key box containing a multitude of keys corresponding to vehicles parked in a garage. These solutions are therefore always restricted to situations in which the vehicles are always parked in a garage. They are therefore expensive since they entail a security service.

Another vehicle-sharing solution, used in sharing systems for the general public in particular, is to structurally modify the vehicle to support this type of function. The vehicle is opened by means of a badge reader, not by a “conventional” key provided by the automobile manufacturer. The vehicle's key is therefore in fact in a key box inside the vehicle, in the glove-box. This transformation of the vehicle brings this solution close to the closed management systems for fleets of vehicles and has the same cost disadvantage.

In addition, there is the problem of authenticating the person who presents himself as being the intended temporary user of the vehicle.

A second problem to be resolved is to correctly associate the vehicle(s) with the content(s) of the key box since, very often, different vehicles will park successively in the same parking place and will therefore share the key box.

### BRIEF DESCRIPTION OF THE INVENTION

The present invention aims to remedy all or part of these drawbacks.

To this end, according to a first aspect, the present invention envisages a secure-closure housing comprising a door movable between a closed position and an open position, the housing comprising a locking device configured to lock the door in the closed position, said housing also comprising:
a means for accessing an object identifier;
a means for accessing an authenticator of a user who is to deposit the object;
means for authenticating a candidate user to determine whether the candidate user corresponds to the authenticator of the user who is to deposit the object;
a device for identifying an object present in the housing, that provides an object identifier or absence of object identification in the housing;
a controller of the locking device, suitable for:
   when the door is closed and the object identification device indicates an absence of object identification in the housing, sending an unlock command to the locking device only after authentication of the user who is to deposit the object;
   sending a lock command after the object identification device has provided an object identifier that corresponds to the identifier received; and p1 triggering an alarm and preventing the locking of the door when the object identification device provides an object identifier that does not correspond to the object identifier received.

Therefore, contrary to what was known in the prior art, the housing made available to different users can only be locked if it is empty or contains a predetermined object. When the housing is empty, for a user to unlock the housing, place an object therein and lock the housing, an authenticator of the user and an identifier of the object, are cumulatively necessary, for the user to be authenticated and the object identified. In the case where the user is authenticated but the object is not identified, an alarm signal perceptible to the user is triggered at the location of the housing.

In the case of vehicle sharing, the housing triggers an alarm if the object placed in the housing, for example the key and/or documents, does not correspond to the object associated to the expected vehicle.

In some embodiments, the means for authenticating the candidate user, to determine whether the candidate user corresponds to the authenticator of the user who is to deposit the object, comprises a means for reading, outside the housing, an identifier carried by the object, and determining whether the identifier read corresponds the object identifier received.

Thanks to these provisions, the user who is to deposit the object is authenticated by the object itself, for example by reading an electronic tag, which simplifies the procedure and makes it possible to verify, even before opening the door of the housing, that the object to be deposited is in the hands of the user and may therefore be located in the housing after the door is locked.

In some embodiments, the method that is the subject of the present invention also comprises:
a means for accessing an authenticator of a user who is to remove the object;
means for authenticating a candidate user to determine, after the door is locked with the object present in the housing, whether the candidate user corresponds to the authenticator of the user who is to remove the object;
the controller of the locking device also being configured such that, when the door is closed and the object identification device indicates that the housing contains an object, an unlock command is sent to the locking device only after authentication of the user who is to remove the object.

Thus, a second authenticator being defined for a second user, the housing does not unlock until authentication by means of this other authenticator.

In some embodiments, the controller is configured such that, after unlocking, if the object identification device indicates that the object remains in the housing beyond a predefined period of time, an alarm perceptible to the user is triggered at the location of the housing.

Therefore, after unlocking, the housing verifies the absence of identification of the object. In the case where the user is authenticated but the object identified remains in the housing beyond a predefined period of time, an alarm signal perceptible to the user is triggered at the location of the housing.

In some embodiments, the means for receiving an object identifier is configured to communicate with an identification server and to receive from the server an identifier of the object.

Thanks to these provisions, the object identifiers can be managed centrally and each housing can easily be made the recipient of an object to be deposited.

In some embodiments, the identification device performs the identification of the predetermined object by recognizing the identification code, the identification code being reproduced in or on the object.

Thanks to these provisions, the user associates a code medium to the object, for example by means of a keyholder or by pasting a label on an administrative document. This makes it easier for the user to utilize the service.

In some embodiments, the object identification device is an electronic tag reader configured to read an electronic tag associated to the object and keeping the identification code.

Thanks to these provisions, regardless of the geometric configuration of the object, upright, inverted or in a holder, the object can be easily and quickly identified. In addition, it is more complicated to falsify an electronic tag than a printed label. The service can therefore be made secure by utilizing electronic tags.

In some embodiments, the controller is configured to send the alarm by light and/or sound means to a user of the housing.

Thanks to these provisions, the user is immediately alerted to an error on his part.

In some embodiments, the controller is configured to send the alarm to an alarm reception server.

Thanks to these provisions, the alarms can be memorized and time-stamped, which ensures traceability for the steps of the service.

In some embodiments, the housing that is the subject of the present invention comprises an emitter-receiver configured to communicate with an authentication server and receive from the server at least one user authenticator.

Thanks to these provisions, a server can manage the user authenticators centrally and each housing can easily be made accessible to each user of the service.

In some embodiments, the housing that is the subject of the present invention comprises an emitter-receiver configured to send a user authenticator read on or in the object by the authentication means to an authentication server and receive from the authentication server information on the correspondence between the authenticator read and a user authenticator.

Thanks to these provisions, authentication is performed by the server in a more secure way than authentication performed by the housing.

In some embodiments, the authentication means comprise a keypad, and the authentication means are configured to authenticate the user through entry of an authenticator on the keypad and comparison with an authenticator calculated in the absence of a server connection.

Thanks to these provisions, the user can receive a code on a communicating portable terminal, eg a mobile phone, and enter it. Consequently, there is no need for a physical key.

In some embodiments, at least one user authenticator is single-use.

Thanks to these provisions, the risk of an authenticator being captured and reused by an unauthorized third party is reduced.

In some embodiments, at least one user authenticator has a limited time of use.

Thanks to these provisions, the risk of an authenticator being captured and reused by an unauthorized third party is reduced.

In some embodiments, the door is vertically slidingly movable between the closed position and the open position, such that gravity keeps the door in the closed position in the absence of another force, and the locking device comprises a notch in the door and a pin secured to the housing, the pin being maintained in the notch by a spring when the door is closed.

Thanks to these provisions, even if there is a power failure, the object deposited by the user is protected by the door of the housing.

In some embodiments, the locking device also comprises means for moving the pin in translation, configured to release it from the notch and thus unlock the door on command from the controller.

In some embodiments, the housing that is the subject of the present invention comprises a single lock for maintenance opening, and no apparent fastenings.

In this way, the housing is protected from physical attack, this being generally made on fastenings.

According to a second aspect, the present invention envisages a method of transmitting an object between users utilizing another secure-closure housing comprising a door movable between a closed position and an open position, the housing comprising a locking device configured to lock the door in the closed position, that comprises:
a step of accessing an object identifier;
a step of accessing an authenticator of a user who is to deposit the object;
a step of authenticating a candidate user to determine whether the candidate user corresponds to the authenticator of the user who is to deposit the object;
a step of identifying an object present in the housing, that provides an object identifier or absence of object identification in the housing;
a step, when the door is closed and the object identification device indicates an absence of object identification in the housing, of sending an unlock command to the locking device only after authentication of the user who is to deposit the object;
and, after the door is unlocked:
   a step of sending a lock command after the object identification step has provided an object identifier that corresponds to the identifier received; and
   a step of triggering an alarm and preventing the door being locked when the object identification step provides an object identifier that does not correspond to the object identifier received.

In some embodiments,

In some embodiments, the step of authenticating the candidate user, to determine whether the candidate user corresponds to the memorized authenticator of the user who is to deposit the object, comprises a step of reading, outside the housing, an identifier carried by the object, and determining whether the identifier read corresponds to the object identifier received.

In some embodiments, the method that is the subject of the present invention also comprises:
a step of accessing an authenticator of a user who is to remove the object;
a step of authenticating a candidate user to determine, after the door is locked with the object present in the housing, whether the candidate user corresponds to the memorized authenticator of the user who is to remove the object; and
when the door is closed and the object identification device indicates that the housing contains an object, to send an unlock command to the locking device only after authentication of the user who is to remove the object.

In some embodiments, the method that is the subject of the present invention also comprises, after unlocking, if the object identification step indicates that the object remains in the housing beyond a predefined period of time, a step of triggering an alarm perceptible to the user at the location of the housing.

According to a third aspect, the present invention envisages use of a housing that is the subject of the present invention for vehicle sharing, a first user inserting into the housing at least a vehicle key and a second user retrieving the key in the housing.

As the particular features, advantages and aims of this method and this use are similar to those of the housing that is the subject of the present invention, they are not repeated here.

### BRIEF DESCRIPTION OF THE FIGURES

The invention will be better understood after reading the description that follows, given solely as an example, made with reference to the figures included in an appendix, in which:

FIG. 1 represents a first embodiment of a secure housing according to the invention with its communication environment;

FIG. 2 represents a flowchart of a method for storing a key;

FIG. 3 represents a flowchart of a method for the start of a rental;

FIG. 4 represents a flowchart of a method for the end of a rental;

FIG. 5 represents a particular embodiment of the secure housing;

FIGS. 6 and 7 represent two detail views of the locking of the door of the embodiment shown in FIG. 5;

FIG. 8 represents, in the form of a logical diagram, a particular embodiment of the housing that is the subject of the present invention, in communication with a portable communicating terminal and with a reservation server; and

FIG. 9 represents, in the form of a logical diagram, steps in a particular embodiment of the method that is the subject of the present invention.

### DESCRIPTION OF EMBODIMENTS

Throughout the description, the term an “object” refers to a set of one or several objects, individually or collectively pre-identifiable, and having to be deposited or removed all at the same time during a housing opening/closing operation. Thus, a key of a vehicle and the administrative documents (ownership certificate and insurance certificate) jointly form an object. An object to be deposited and then removed from a housing is associated to an identifier. It is noted that each part of the set can be physically associated to a portion of the identifier of the object. For example, a vehicle key can bear an electronic tag bearing a first code and the administrative documents can bear a second electronic tag bearing a second code, the first and second codes jointly forming the identifier of the object comprising the key and the administrative documents.

In order to materialize the described embodiments in a context, this is the sharing of vehicles in a general public environment, also called “vehicle sharing”. For example, vehicle owner/users make this vehicle available in a specified place and for a specified length of time via a website. Third-party temporary users, ie other than the owner or his close acquaintances, make request to rent and use the vehicle, always via the website.

The website therefore has several functions:
Managing the available fleet of vehicles;
Associating a temporary user to a vehicle according to several parameters, of which the place, time and cost are the main ones;
Managing the vehicle rental by giving access to the vehicle, checking that the vehicle is returned according to the specified procedures; and
Ensuring the various related payments are made.

In this context, a housing will be described that is preferably associated to a parking place, intended to receive the key and administrative documents (registration certificate, insurance certificate) of the vehicle located near it.

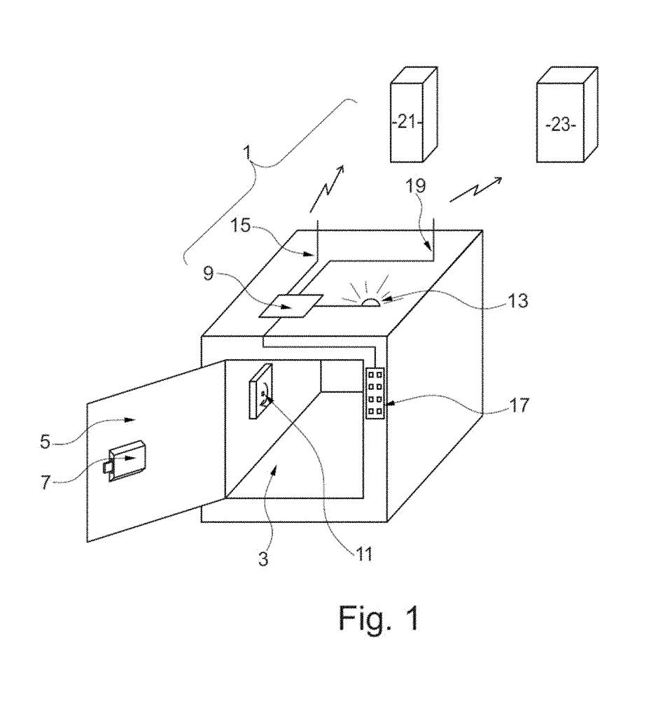

With reference to FIG. 1, a housing 1 comprises an interior volume 3 closed by a door 5. The door 5 is movable between a closed position, in which the door 5 closes the interior volume 3, and an open position, which allows access to the interior volume 3.

The door 5 comprises a locking device 7 configured to lock the door in the closed position. The locking device 7 is, for example, a lock, latch, electric latch, or any other device known to the person skilled in the art for securely closing a door.

The housing 1 also comprises a controller 9 of the locking device 7. The controller 9 is connected to an object identification device 11. Typically, the controller 9 is an electronic computing unit that commands electronic means for operating the locking device 9.

The object identification device 11 is, for example, a reader of electronic tags, or RFID (“Radio Frequency Identification”) or NFC (“near field communication”) tags, 1D or 2D barcodes, or QR codes (“OR code” is a registered trademark).

The object to be identified, typically the key of the vehicle and the administrative documents, are associated to one or more labels keeping an identification code, or identifier, such that the identification device 11 is able to read the identifier, or identifiers, of the key and documents.

The controller 9 is connected to an alarm device 13, such as a flashing light or a generator of a sound signal. In this way, if the controller 9 determines that the identifier read does not correspond to an expected identifier, the controller 9 can trigger an alarm on the alarm device 13. This alarm signals to the temporary user that, for example, he has forgotten to put the documents in the housing or that he has made a mistake with the key.

Preferably, the housing 1 comprises an emitter/receiver 15 connected to the controller 9 so as to allow the controller 9 to establish data communication with an identification server 21.

This identification server 21 is, for example, connected to the sharing management web server. Depending on the vehicle expected in the parking place, the identification server 21 is able to indicate to the controller 9 each identification code corresponding to the expected vehicle and therefore each identification code of a key and/or document having to be located in the housing 1.

Reciprocally, the controller 9 is able to indicate to the identification server 21 that each expected object is in the housing 1, or that there is a problem/an alarm because no expected object is present, or only a portion of the expected set is present, or an object, for example a key and/or a document, that does not correspond to the expected vehicle is present in the interior volume 3.

The housing 1 also comprises means 17 for authenticating a temporary user, connected to the controller 9. These authentication means 17 are, for example, a door entry system with which the temporary user enters a secret code associated to the temporary user. These authentication means 17 are, preferably, an emitter/receiver for an electronic tag, or an emitter/receiver utilizing the Bluetooth protocol (registered trademark) enabling a data link with a communicating portable terminal (for example a mobile telephone) of the temporary user, this terminal running a dedicated application making it possible to send an authenticator to the housing 1.

Therefore, the controller 9 sends an unlock command to the locking device 7 only after authentication of the temporary user.

Preferably, the controller 9 is connected to a second emitter/receiver 19 for communicating with an authentication server 23. The controller 9 can therefore receive from the authentication server 23 the authenticator of the temporary user in order to perform the authentication procedure locally. In a variant, the authentication device 17 is connected directly with the authentication server 23, which performs the authentication procedure and sends the controller 9 information about a successful authentication or not.

Preferably, the temporary user has an authenticator that is unique, ie no other user has the same authenticator, non-reusable and with a limited time of use. This authenticator is managed, for example generated randomly, and associated to a temporary user, by the authentication server 23 as part of the authentication procedure.

In other words, not only does the authentication procedure serve to ensure that the temporary user is the person he claims to be, but also that he is the person who is to use this vehicle at a specific time.

It should be noted that, in a variant in which the housing 1 has no connection, or only a limited connection, to the authentication server 23, there are cryptographic procedures for generating and checking a single-use authenticator with a limited lifespan, in which the housing 1 has no need to call a server and the expected authenticator is recalculated. For example, this authenticator is calculated by a mathematical function applied to a time-stamp and an identifier of the housing 1.

The temporary user receives the authenticator, preferably via a mobile telephone network, for example by means of a short message (“SMS”, for short message system) or a message received by the dedicated application installed on his communicating portable terminal.

The operating mode of the key housing is as follows.

As a preliminary remark, and to avoid making the text needlessly cumbersome, only the management of a key will be described. The person skilled in the art will easily generalize this to the management of a key associated to other objects or documents.

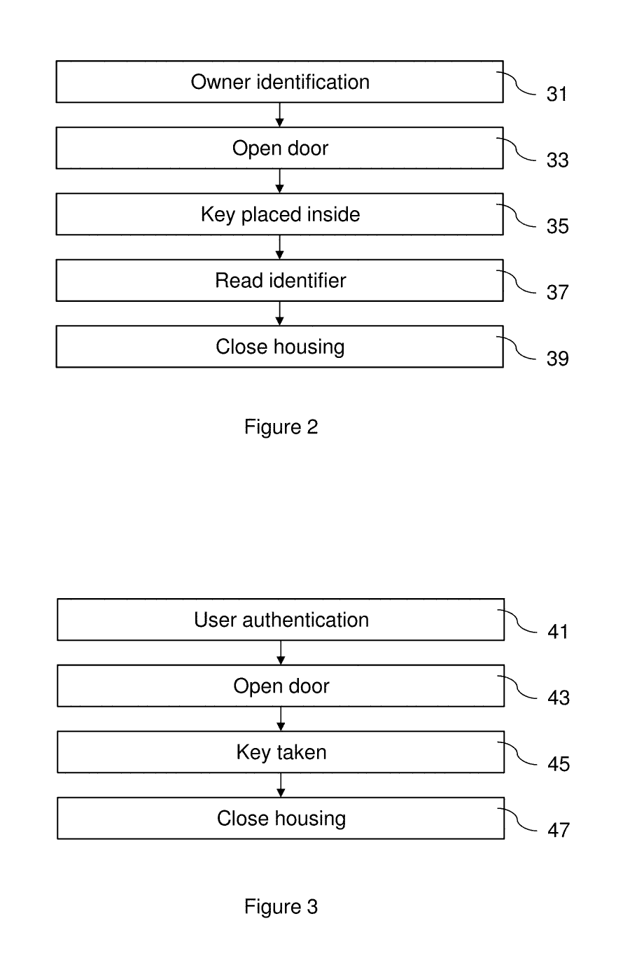

To begin, the procedure for storing a key is described with regard to FIG. 2.

In a preliminary step, for example by using a vehicle-sharing website, the owner of the rental vehicle has registered his vehicle and has received in return an RFID tag to be stuck on the key of the vehicle.

The housing 1 is in the state closed and locked with no key identifier.

In step 31, the owner/user identifies himself as the person who is going to deposit a key.

In step 33, the housing 1 accepts the identification and opens the door.

In step 35, the owner/user places the key in the housing.

In step 37, the identification device 11 reads the identifier of the key, which is sent to the server 21.

In step 39, the door of the housing 1 is closed and locked.

From that point on, the system considers that the vehicle whose key is in the housing 1 is parked in the place associated to the housing 1 and is ready to be shared.

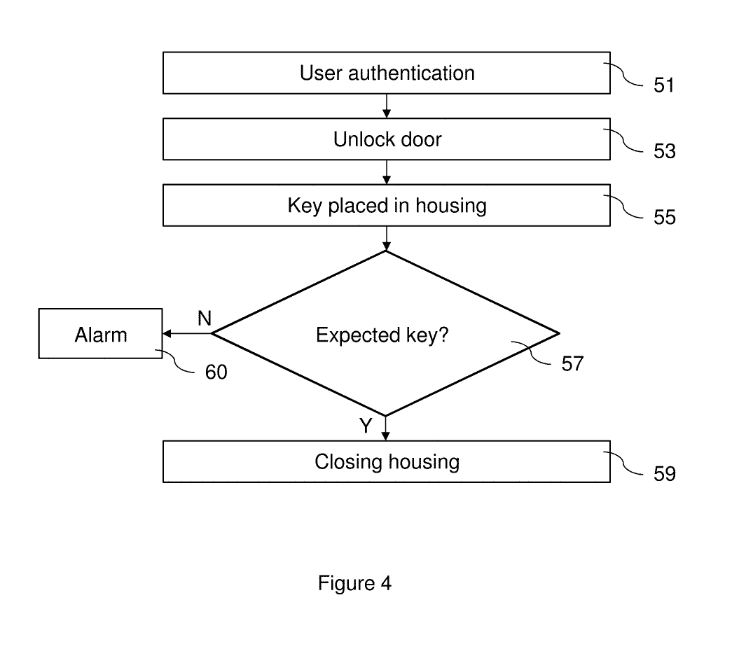

With reference to FIG. 3, the procedure for the rental of a vehicle comprises the following steps.

The housing 1 is in the locked closed state with an object in the interior volume 3, typically a key, identified.

In step 41, the temporary user identifies himself, for example by entering a unique code supplied to him by the vehicle-sharing website.

In step 43 the housing 1, having verified that this is the expected user, unlocks the door. If this is not the expected temporary user, the housing 1 remains locked and an alarm is triggered both locally and at the authentication server (not shown).

In step 45, the temporary user takes the key. The housing 1 recognizes that the key has been taken because the identification device 11 no longer receives an identification signal. The housing 1 sets its status to “empty” and sends the information to the identification server. The system then considers that the temporary user has picked up the vehicle and the rental has begun.

In step 47, after an action by the temporary user or a time delay, the door closes and locks itself.

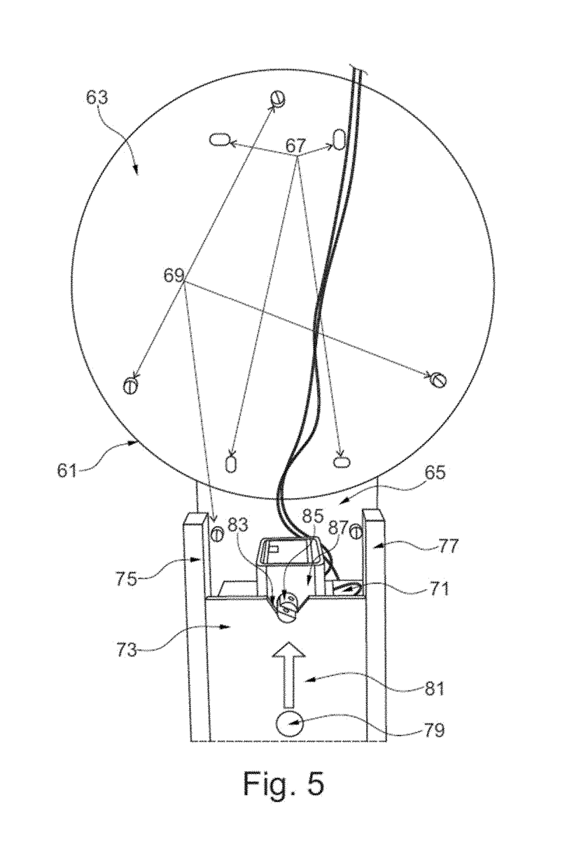

The procedure for the end of the rental and return of the key comprises the following steps, FIG. 4.

The housing 1 is in the state closed, locked and empty.

In step 51, the temporary user identifies himself, for example by entering a unique code supplied to him by the vehicle-sharing website.

In step 53 the housing 1, having verified that this is the expected user, unlocks the door. If this is not the expected temporary user, the housing 1 remains locked and an alarm is triggered both locally and at the authentication server (not shown).

In step 55, the temporary user places the key in the housing 1.

In step 57, the housing 1 verifies that the key deposited is the expected key.

If it is the right key, in step 59 the housing closes and locks itself. The system considers that the vehicle has been returned and the rental ends. Notification is sent to the temporary user and the owner/user to inform them of the end of the customer path.

If this is not the right key, in step 60 the housing 1 triggers a local alarm and informs the authentication server. The local alarm can let the temporary user realize that he has made a mistake, for example depositing the wrong key or forgetting to place it in the housing 1. The housing 1 being open, the temporary user can correct his error by depositing the expected key, and the procedure continues at step 59.

If the error is not corrected within a predefined length of time, the alarm triggers corrective procedures at the system level, such as an operator calling the temporary user and/or the owner/user, etc.

Therefore it can be seen that, advantageously, through this key identification, there is accurate and permanent knowledge of the fleet of vehicles available, whereas many malfunctions are possible without key identification, such as forgetting to put the key in the housing 1 with the consequence that the next temporary user cannot use the system as long as the system has not, at least, called the previous temporary user so that he brings the key back.

We are now going to describe a particularly advantageous mechanical embodiment of the key housing 1 in the context of vehicle sharing. It will easily be understood that this mechanical embodiment can be implemented independent of the functionalities described above and that, reciprocally, the above functionalities can be implemented with housings having different mechanical structures.

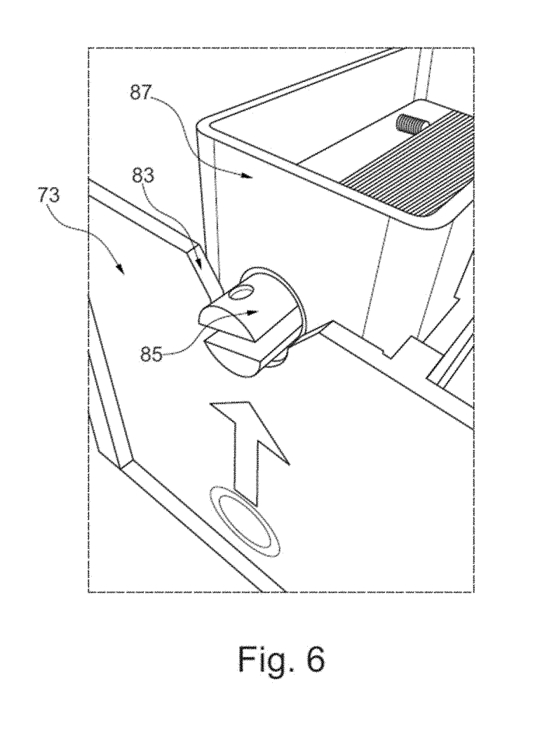

With reference to FIG. 5, the housing 1 comprises a base plate 61 consisting of a circular portion 63 prolonged with a substantially rectangular portion 65.

The base plate 61 comprises holes 67 allowing the housing 1 to be securely attached on a support such as a wall.

The base plate 61 also comprises attachment mounts 69 allowing a protective casing to be fixed.

In its rectangular portion 65, a reinforced container 71 corresponding to the interior volume of the housing is securely fastened onto the base plate 61.

This container 71 is closed by a door 73. The door 73 slides with a vertical translational movement along two slides 75, 77.

The door 73 comprises a concavity 79 allowing a user to insert a finger in order to lift it in the direction of the arrow 81.

The assembly is then mounted such that the arrow marks the vertical axis upwards.

On its upper surface, the door 73 comprises a notch 83 in which a pin 85 is positioned.

The pin 85 is mounted on a base 87 secured to the base plate 61, and therefore the container 71.

In the figure, the pin 85 is shown in the locking position, ie the pin 85 prevents the door from rising and therefore giving access to the container 71.

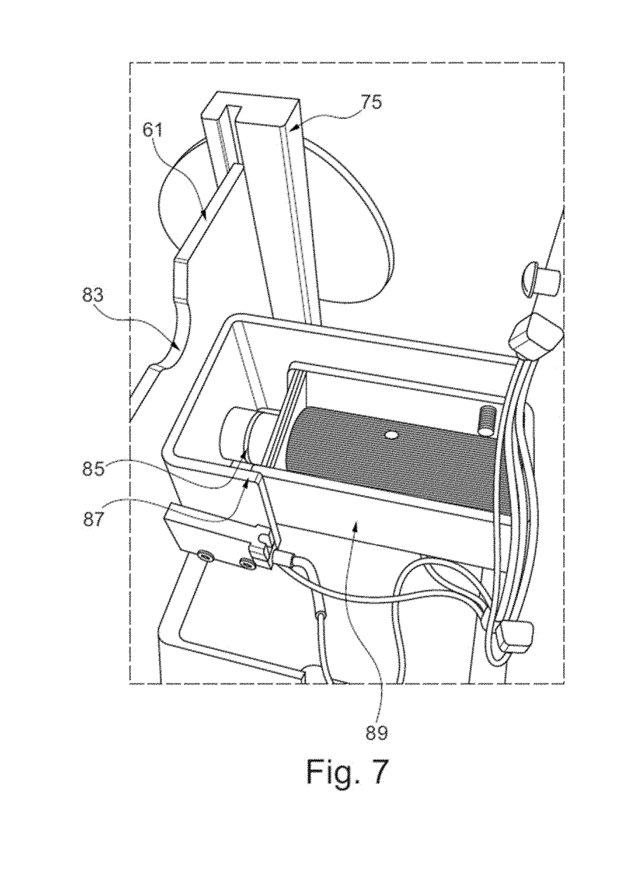

FIG. 6 shows a close-up view of the pin 85 in the locking position.

The pin 85 is mounted on the base 87 so as to be able to make a translational movement perpendicular to the plane of the door 61 between the locked position and an unlocked position, enabling the door 61 to slide freely, as shown in FIG. 7. This translational movement of the pin is controlled by an electromagnet 89.

For security, the rest position of the pin corresponds to the locked position.

The circular portion 63 contains the electronic control portion and the protective casings have suitable openings to clearly allow direct access to the door, and also to position a user interface in the form of a small alphanumeric screen and/or a digicode keypad.

The protective casings are arranged, when they are in position, to not leave visible any screw or means for disassembly without damage to the equipment. Thus, the circular portion of the casing is clipped onto the attachment mounts 69 by a rotational movement once this circular portion is positioned. The parallelepiped portion of the casing slides and fastens onto the attachment mounts 69 of the rectangular portion 65 of the mount such that, in position, this parallelepiped portion prevents any rotation of the circular portion and therefore any unlocking.

Thus, the casings are such that no screw or fastening is visible and the arrangement of their surfaces prevents damage or attempted break-ins. They are locked in position by a single lock that only the maintenance technicians have the key to.

The invention has been illustrated and described in detail in the drawings and the above description. The latter must be considered as illustrative and given as an example, and not as limiting the invention solely to this description. Many variants of realization are possible.

For example, the two servers and the emitter/receivers can be combined into a single server and a single emitter/receiver.

In the claims, the term “comprising” does not exclude other elements and the indefinite article “a” does not exclude a plurality.

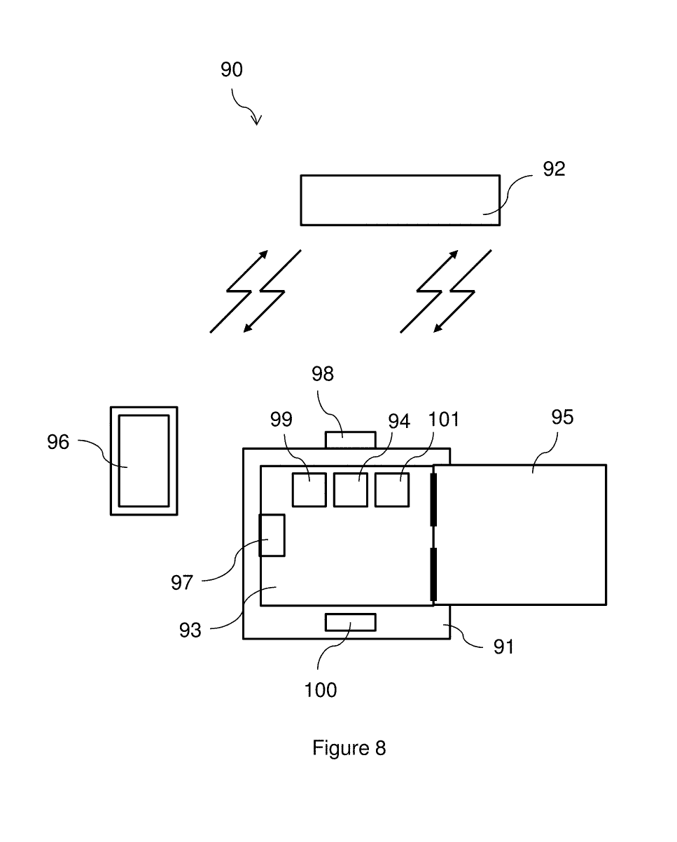

FIG. 8 shows a vehicle-sharing system 90. This system implements only a single server, which hosts a website and manages object identifiers and user authenticators. The system 90 comprises a secure-closure housing 91 comprising an interior volume 93 and a door 95 movable between a closed position and an open position (shown, in FIG. 8, in the open position), the housing 91 comprising an electrically-controlled locking device 97 configured to lock the door in the closed position.

The housing 91 also comprises a means 98 for accessing an object identifier associated to a time-slot for depositing this object. Preferably, this access means 98 communicates with a server 92, over a mobile telephone network or a network of linked objects, for example Sigfox (registered trademark) or Lora (registered trademark).

The access means 98 can, preferably, be:
a memory inside the housing 91, a memory that keeps each object identifier and each deposit time-slot of the object thus identified, from the server 92, such that the controller 99 verifies that an object identifier read on an object is the one authorized for the current time-slot; or
an access to the server 92, to which the controller 99 sends each object identifier read on an object, the server 92 then performing the verification that said identifier is the one authorized for the current time-slot.

The internet server 92 hosts a website on which:
a user wishing to make his vehicle available to a third party can select a location, for example a parking place, where he will leave his vehicle available at a time of his choice, the server sending an identifier of an object, keys and/or administrative documents of the vehicle, to the housing associated to the location selected, and a time-slot during which this object must be deposited in this housing; and
a user wishing to use a vehicle made available in this way chooses the location and/or the vehicle, the server sending this user and the housing associated to the location and to the vehicle an authenticator allowing the third-party user to be authenticated at the housing in order to access the object, and a time-slot during which this authenticator can be used.

The housing 91 comprises a device or reader 101 for identifying an object present in the interior volume 93 of the housing 91. When an object equipped with an identifier, for example an electronic tag or a printed code, is placed in the interior volume 93, the identification reader 101 reads this object identifier and supplies this identifier to a controller 99 of the locking device 97. The controller 99 is configured to send a lock command to the locking device 97 after the object identification reader 101 has supplied an object identifier that corresponds to the identifier received by the housing 91 from the server 92 for the current time. The controller 99 is also configured to trigger an alarm and prevent the door being locked when the object identification reader 101 has supplied an object identifier that does not correspond to the object identifier received by the housing 91 from the server 92 for the current time.

The housing 91 also comprises a means 94 for accessing at least one authenticator of a user and a time-slot for using this authenticator. The access means 94 can, preferably, be:
a memory inside the housing 91, a memory that keeps the user authenticators and use time-slots from the server 92, such that the controller 99 verifies that a user authenticator received from a user is the one authorized for the current time-slot;
an access to the server 92, to which the controller 99 sends each user authenticator received from a user, the server 92 then performing the verification that said authenticator is the one authorized for the current time-slot; or
a determinist generator of user authenticators, an identical generator being utilized by the server 92, which sends this authenticator to the user for his authentication. Preferably, this deterministic generator uses a current time-slot and a unique housing identifier to generate the user authenticators, the controller 99 verifying that a user authenticator received from a user is the authorized authenticator.

The housing 91 also comprises means 100 for authenticating a user, connected to the controller 99, to determine whether the user corresponds to the authenticator memorized by the memorization means 94. The authentication means 100 can be a code lock (“digicode”, see FIG. 1, reference 17), or, as in FIG. 8, an electronic tag reader or a reader of a code displayed on a screen of a communicating portable terminal 96 or communicated at short distance by such a terminal 96. The user is therefore authenticated by what he knows, ie a code, or by what he has, ie a code medium (an electronic tag) or a communicating portable terminal having received a user authenticator. In a variant (not shown), authentication of the user is performed using a biometric measurement, for example recognition of a fingerprint, hand shape, voice or face.

The authentication means 100 are configured to compare the authenticator obtained from the user with the authenticator that the access means 94 has access to.

The controller 99 is configured such that, when the door 95 is closed and the object identification device 101 indicates that the interior volume 93 of the housing 91 contains no object, it only sends an unlock command to the locking device 97 after authentication of the user by the authentication means 100.

Therefore, contrary to what was known in the prior art, the housing 91 made available to different users can only be locked if it is empty or contains a predetermined object. When the housing 91 is empty, for a user to unlock the door 95 of the housing 91, place an object therein and trigger the locking of the door 95 of the housing 91, an authenticator of the user and an identifier of the object are associated to a first time-slot and, solely during this first time-slot and cumulatively, the user is authenticated and the object is identified. In the case where the user is authenticated but the object is not identified, an alarm signal perceptible to the user is triggered at the location of the housing 91.

In addition, another authenticator is associated to a second time-slot subsequent to the first time-slot, the door 95 of the housing 91 not being unlocked until authentication, by means of this second authenticator, during this second time-slot. In addition, after unlocking followed by a predefined period of time, for example ten seconds, the housing 91 verifies the absence of identification of the object. In the case where the user is authenticated but the object identified remains in the housing beyond this predefined period of time, an alarm signal perceptible to the user is triggered at the location of the housing 91.

Each successful identification, successful authentication and alarm is sent to the server 92, where it is time-stamped and memorized, for traceability. Preferably, the alarm is sent to a user of the housing 91 by light and/or sound means 103 and/or by means of the communicating mobile terminal 96.

Preferably, each authenticator is single-use and/or has a limited time of use, by means of the time-slot to which the authenticator is associated.

In some embodiments, the means 100 for authenticating the user are means for authenticating the object that is to be deposited in the housing 91 during the current time-slot, while the object is outside the housing 91, by reading and recognizing the object borne by the housing, this identifier being identical to the object identifier received by the housing 91 from the server 92, for the current time-slot. In these embodiments, where the identification of the object is performed outside the housing 91, the housing preferably uses an identifier reader separate from the object identification device 101 located inside the interior volume 93 of the housing 91. Therefore, depending on the position of the object, two different identifier readers are used, and reading an identifier by an identifier reader makes it possible to know the position of the object, inside or outside the housing 91.

It is noted that authentication of the user is therefore performed by recognition of the user or by the presence of the object bearing the received identifier.

In a variant, the authentication and/or identification functions are transferred to the server 92, the housing 91 thus serving as a peripheral authentication and/or identification reader for the server 92, which sends to the housing 91 the lock and unlock commands and the commands to emit alarm signals.

In a variant, a subscriber to the service implemented by the website hosted by the server 92 can leave his vehicle-sharing vehicle key in any empty housing that is not yet waiting for an object, the server 92 recognizing this key and assigning it to any requestor, who can request it subsequently.

In this case, the secure housing has three statuses:
empty, not waiting for a person (for depositing in vehicle sharing);
empty but “reserved” for the deposit of an expected key; and
containing a key.

Preferably, the status of the housing 91 is visible from outside the housing 91, for example by means of diodes of different colors.

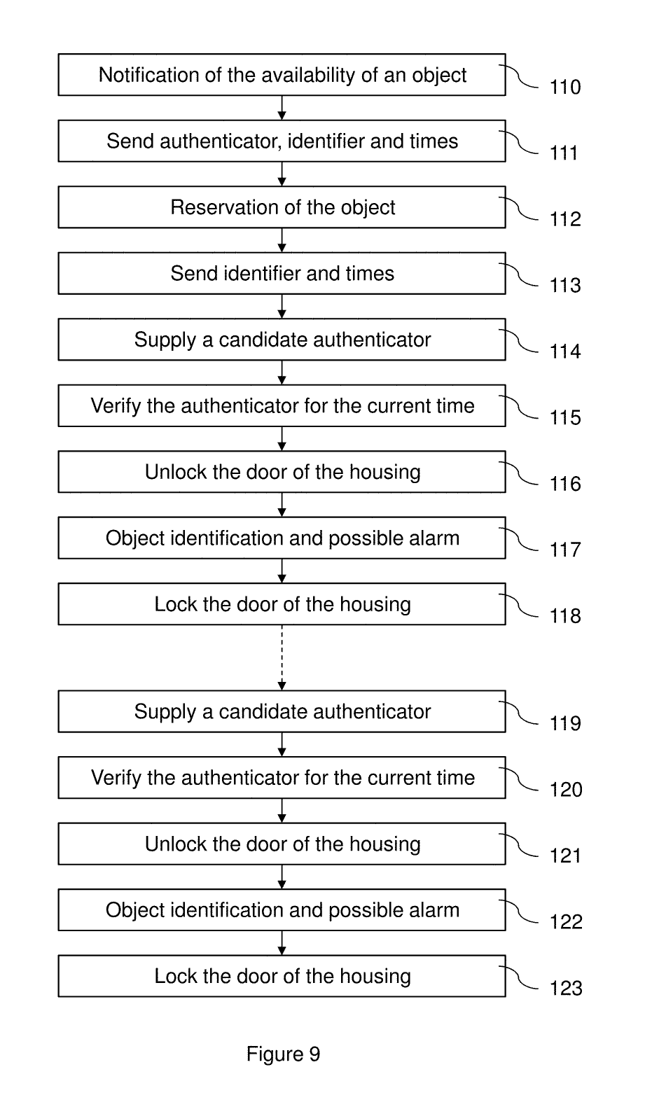

In the particular embodiment of the method that is the subject of the present invention, illustrated in FIG. 9, the server sends the user authenticators and object identifiers to the housing. As indicated above, in a variant, the authentication and/or identification are performed by the server, and/or each authenticator is calculated deterministically by the housing.

In this embodiment, during a step 110, by means of an internet server hosting a website, a first user (also referred to in the description as “user who is to deposit an object”) wishing to make his vehicle available to a third party selects a location, for example a parking place, where he will leave his vehicle available at a time of his choice. During a step 111, the server sends the user who is to deposit an object an authenticator, to be used during access to the housing. During the same step 111, the server sends to the housing associated to the selected location:
an authenticator of the user who is to deposit the object;
an identifier of an object, keys and/or administrative documents of the vehicle; and
a deposit time-slot for the object, during which this object must be deposited in this housing.

During a step 112, a second user (also referred to in the description as “user who is to remove the object”) wishing to use a vehicle made available in this way chooses, preferably on the same website, the location and/or the vehicle. During a step 113, the server sends this user confirmation of the location and vehicle reserved, and sends to this user and to the housing associated to the location and the vehicle:
an authenticator allowing the third-party user to be authenticated at the housing in order to access the object; and
a removal time-slot for the object, later than the deposit time-slot for the object, during which this authenticator can be used.

During a step 114, the housing being empty and the door of the housing being locked, a candidate user who is to deposit an object arrives in front of the housing and supplies a user authenticator.

During a step 115, the controller of the housing verifies that the authenticator of the user requesting access to the interior volume of the housing corresponds to the user authenticator that is to deposit an object received from the server, for the current time-slot. If not, the door of the housing remains locked.

If yes, during a step 116, the controller unlocks the door of the housing and reads the identifier of the object deposited in its interior volume. If, following a predefined period of time, for example ten seconds, no object identifier is read or if an object identifier read does not correspond to the object identifier received from the server for the current time-slot, the controller triggers an alarm perceptible to the user at the location of the housing, during a step 117.

Only if the object identifier read corresponds to the object identifier received from the server, during a step 118, does the controller lock the door of the housing.

Therefore, contrary to what was known in the prior art, the housing made available to different users can only be locked if it is empty or contains a predetermined object. When the housing is empty, for a user to unlock the door of the housing, place an object therein and trigger the locking of the door of the housing, solely during the time-slot assigning to the depositing of an object and cumulatively, the user is authenticated and the object is identified. In the case where the user is authenticated but the object is not identified, an alarm signal perceptible to the user is triggered at the location of the housing.

During a step 119, the housing containing an object and the door of the housing being locked, a candidate user who is to remove the object arrives in front of the housing and supplies a user authenticator.

During a step 120, the controller of the housing verifies that the authenticator of the user requesting access to the interior volume of the housing corresponds to the authenticator, received from the server, of the user who is to deposit an object, for the current time-slot. If not, the door of the housing remains locked.

If yes, during a step 121, the controller unlocks the door of the housing and reads the identifier of the object deposited in its interior volume. If, following a predefined period of time, for example ten seconds, no object identifier is read or is different from the identifier of the object present in the housing, during step 119, the controller triggers an alarm perceptible to the user at the location of the housing, during a step 122.

The controller locks the access to the interior volume of the housing, either when no object identifier is read, or when an object identifier is read during a predefined period of time, for example one minute, after the triggering of the alarm, during a step 123.

In this way, the door of the housing is not unlocked until the user who is to remove the object is authenticated. In addition, after unlocking followed by a predefined period of time, for example ten seconds, the housing verifies the absence of identification of the object.

In the case where the user is authenticated but the object identified remains in the housing beyond this predefined period of time, an alarm signal perceptible to the user is triggered at the location of the housing.

Each successful identification, successful authentication and alarm is sent to the server, where it is time-stamped and memorized, for traceability. Preferably, the alarm is sent to a user of the housing by light and/or sound means and/or by means of the communicating mobile terminal.

Preferably, each authenticator is single-use and/or has a limited time of use, by means of the time-slot to which the authenticator is associated.

In some variants, the means for authenticating the user who is to deposit the object are means for authenticating the object that the user is to deposit in the housing during the current time-slot. This authentication is therefore performed while the object is outside the housing, by reading and recognizing the identifier borne by the object, and verification that this identifier is identical to the object identifier received by the housing from the server, for the current time-slot. In these variants:
during step 114, the housing being empty and the door of the housing being locked, a candidate user who is to deposit an object arrives in front of the housing and the object he carries supplies a candidate object identifier; and
during a step 115, the controller of the housing verifies that the identifier of the candidate object corresponds to the identifier of the object that is to be deposited received from the server, for the current time-slot. If not, the door of the housing remains locked.

Authentication of the user is therefore performed by recognition of the user or by the presence of the object bearing the received identifier close to the housing.

The return of the object or its transfer to a third user is performed in the same way, by performing steps 110 to 123, the roles of the users being reversed.

1. Secure-closure housing comprising a door movable between a closed position and an open position, the housing comprising a locking device configured to lock the door in the closed position, that further comprises:
a means for accessing an object identifier;
a means for accessing an authenticator of a user who is to deposit the object;
means for authenticating a candidate user to determine whether the candidate user corresponds to the authenticator of the user who is to deposit the object;
a device for identifying an object present in the housing, that provides an object identifier or absence of object identification in the housing;
a controller of the locking device, suitable for
when the door is closed and the object identification device indicates an absence of object identification in the housing, sending an unlock command to the locking device only after authentication of the user who is to deposit the object;
sending a lock command after the object identification device has provided an object identifier that corresponds to the identifier received; and
triggering an alarm and preventing the locking of the door when the object identification device provides an object identifier that does not correspond to the object identifier received.

2. Housing according to claim 1, wherein the means for authenticating the candidate user, to determine whether the candidate user corresponds to the authenticator of the user who is to deposit the object, comprises a means for reading, outside the housing, an identifier carried by the object, and determining whether the identifier read corresponds the object identifier received.

3. Housing according to claim 1, that further comprises:
a means for accessing an authenticator of a user who is to remove the object;
means for authenticating a candidate user to determine, after the door is locked with the object present in the housing, whether the candidate user corresponds to the authenticator of the user who is to remove the object;
the controller of the locking device being further configured to send to the locking device an unlock command, when the door is closed and the object identification device indicates that the housing contains an object, and only after authentication of the user who is to remove the object.

4. Housing according to claim 3, wherein the controller is configured to trigger an alarm perceptible to the user at the location of the housing if, after unlocking, the object identification device indicates that the object remains in the housing beyond a predefined period of time.

5. Housing according to claim 1, wherein the means for receiving an object identifier is configured to communicate with an identification server and to receive from the server an identifier of the object.

6. Housing according to claim 5, wherein the identification device performs the identification of the predetermined object by recognizing the identification code, the identification code being reproduced in or on the object.

7. Housing according to claim 6, wherein the object identification device is an electronic tag reader configured to read an electronic tag associated to the object and keeping the identification code.

8. Housing according claim 1, wherein the controller is configured to send the alarm to an alarm reception server.

9. (canceled)

10. Housing according to claim 1, that further comprises an emitter-receiver configured to communicate with an authentication server and to receive from the server at least one user authenticator.

11. Housing according to claim 1, that further comprises an emitter-receiver configured to send a user authenticator read on or in the object by the authentication means to an authentication server and receive from the authentication server information on the correspondence between the authenticator read and a user authenticator.

12. Housing according to claim 1, wherein the authentication means comprise a keypad, and the authentication means are configured to authenticate the user through entry of an authenticator on the keypad and comparison with an authenticator calculated in the absence of a server connection.

13. Housing according to claim 1, wherein at least one user authenticator is single-use.

14. Housing according to claim 1, wherein at least one user authenticator has a limited time of use.

15. Housing according to claim 1, wherein the door is vertically slidingly movable between the closed position and the open position, such that gravity keeps the door in the closed position in the absence of another force, and the locking device comprises a notch (83) in the door and a pin (85) secured to the housing, the pin being maintained in the notch by a spring when the door is closed.

16. Housing according to claim 15, wherein the locking device further comprises means (89) for moving the pin in translation, configured to release it from the notch and thus unlock the door on command from the controller.

17. Housing according to claim 15, that comprises a single lock for maintenance opening, and no apparent fastenings.

18. Method of transmitting an object between users utilizing another secure-closure housing comprising a door movable between a closed position and an open position, the housing comprising a locking device configured to lock the door in the closed position, that comprises:
accessing an object identifier;
accessing an authenticator of a user who is to deposit the object;
authenticating a candidate user to determine whether the candidate user corresponds to the authenticator of the user who is to deposit the object;
identifying an object present in the housing, that provides an object identifier or absence of object identification in the housing;
sending, when the door is closed and the object identification device indicates an absence of object identification in the housing, of sending an unlock command to the locking device only after authentication of the user who is to deposit the object; and, after the door is unlocked:
sending a lock command after the object identification step has provided an object identifier that corresponds to the identifier received; and
triggering an alarm and preventing the door being locked when the object identification step provides an object identifier that does not correspond to the object identifier received.

19. Method according to claim 18, wherein authenticating the candidate user, to determine whether the candidate user corresponds to the memorized authenticator of the user who is to deposit the object, comprises reading, outside the housing, an identifier carried by the object, and determining whether the identifier read corresponds to the object identifier received.

20. Method according to claim 18, that further comprises:
accessing an authenticator of a user who is to remove the object;
authenticating a candidate user to determine, after the door is locked with the object present in the housing, whether the candidate user corresponds to the memorized authenticator of the user who is to remove the object; and
sending, when the door is closed and the object identification device indicates that the housing contains an object, an unlock command to the locking device only after authentication of the user who is to remove the object.

21. Method according to claim 20, that further comprises after unlocking, if the object identification indicates that the object remains in the housing beyond a predefined period of time, triggering an alarm perceptible to the user at the location of the housing.

22. (canceled)
